(19) United States
(12) Patent Application Publication
(10) Pub. No.: US 2015/0306567 A1
(43) Pub. Date: Oct. 29, 2015

(54) CHITOSAN-FUNCTIONALIZED CORDIERITE MONOLITHS AS HEAVY METAL SORBENTS

(71) Applicants: Benedict Yorke JOHNSON, (US); Li LIU, (US); Samuel Odei OWUSU, (US); CORNING INCORPORATED, Corning, NY (US)

(72) Inventors: Benedict Yorke Johnson, Horseheads, NY (US); Li Liu, Painted Post, NY (US); Samuel Odei Owusu, Horseheads, NY (US)

(21) Appl. No.: 14/647,840

(22) PCT Filed: Nov. 26, 2013
(86) PCT No.: PCT/US13/71983

§ 371 Date: May 28, 2015

Related U.S. Application Data
(60) Provisional application No. 61/731,685, filed on Nov. 30, 2012.

(51) Int. Cl. B01J 20/24; B01J 20/32; B01J 20/28; C02F 1/28; B01J 20/10

(52) U.S. Cl. CPC B01J 20/24; C02F 1/288; B01J 20/103; B01J 20/28042; B01J 20/28045; B01J 20/3204; B01J 20/3236; B01J 20/3289; C02F 2101/20

(57) ABSTRACT

Embodiments of a method of making a sorbent comprise providing a monolith having a plurality of internal channels, providing at least one silica coating onto walls of the plurality of internal channels by applying a silica coating solution, and providing at least one chitosan coating on the silica coating by applying a chitosan coating solution.

### CROSS-REFERENCE TO RELATED APPLICATIONS

This application claims the benefit of priority under 35 U.S.C. §119 of U.S. Provisional Application Ser. No. 61/731,685 filed on Nov. 30, 2012, the content of which is relied upon and incorporated herein by reference in its entirety.

### TECHNICAL FIELD

The present disclosure is generally directed to heavy metal sorbents, and is specifically directed to cordierite monoliths functionalized with chitosan for improved heavy metal adsorption.

### SUMMARY

Regulations for controlling the discharge of industrial wastewater containing dissolved concentrations of heavy metals to the environment are being tightened, because of concerns of the levels of heavy metals in surface waters such as streams, rivers and lakes. High concentration of heavy metals in the environment can be detrimental to a variety of living species. Excessive ingestion of these metals by humans can cause accumulative poisoning, cancer, nervous system damage and ultimately death. It is therefore frequently desirable for wastewater be treated to either remove substantially all heavy metals or to reduce the amounts of dissolved heavy metals to levels at which the water is considered safe for both aquatic and human life prior to disposal in surface waters.

The commonly used methods for removing metal ions from aqueous streams include chemical precipitation as hydroxides or sulfides, chemical oxidation or reduction, evaporation, ion exchange, flotation, centrifugation and membrane separation technologies. While the conventional methods can be effective for treating metal bearing effluents for the removal of heavy metal contaminants, these methods require substantial investment for overall process costs, both capital and operational. Therefore, industries such as metal plating and finishing industries continue to seek higher efficiency and more cost-effective technologies for removing heavy metals from their wastewaters.

Research interest into the production of alternative adsorbents to replace the costly adsorbents has intensified in recent years. Attention has been focused on various sorbents, which have metal-binding capacities and are able to remove unwanted heavy metals from contaminated water at low cost. In general, a sorbent can be assumed to be “low cost” if it requires little processing and is abundant in nature, or is a byproduct or waste material from another industry. There have been several low cost adsorbents that have been used for the removal of heavy metals, including, natural materials such as chitosan, zeolites, clay, or certain waste products from industrial operations such as fly ash, coal, and oxides.

Presently, chitosan is attracting considerable interest for removal of heavy metals due to its excellent metal-binding capacities. A number of processes have been developed to remove heavy metals from aqueous water streams using particulate support media coated with chitosan and its derivatives. However, these particulate support systems have the disadvantage of a low accessibility of the internal pore system, a poor flow-through behavior and low adsorption specificity. Thus, novel support materials with optimally adapted properties profiles are needed.

Accordingly, the present disclosure is directed to a monolith structure whose internal walls have been functionalized with chitosan for immobilization of heavy metals in fluid sources, for example, contaminated industrial wastewater. The monolith support of the present disclosure offers several advantages over particulate supports, including a high geometric external surface, structural durability, a low-pressure drop and uniform flow distribution within the support. More particularly, the present sorbents facilitate an environmentally-compatible, low cost and simplified process for removing dissolved heavy metals from aqueous streams without formation of any undesirable byproduct. Specifically, the monolith structures of the present disclosure whose internal walls have been functionalized with chitosan directly interact with wastewater to provide high efficiency heavy metal adsorption.

In one embodiment, a method of making a sorbent is provided. The method comprises providing a monolith having a plurality of internal channels, providing at least one silica coating onto walls of the plurality of internal channels by applying a silica coating solution, and providing at least one chitosan coating on the silica coating by applying a chitosan coating solution.

In another embodiment, a sorbent is provided wherein the sorbent comprises a monolith having a plurality of internal channels, at least one silica coating disposed on walls of the plurality of internal channels, and at least one chitosan coating disposed on the at least one silica coating.

These and additional features provided by the embodiments of the present disclosure will be more fully understood in view of the following detailed description, in conjunction with the drawing.

### BRIEF DESCRIPTION OF THE DRAWING

The following detailed description of specific embodiments of the present disclosure can be best understood when read in conjunction with the drawings enclosed herewith.

FIG. 1 schematically depicts the dip coating of sorbents in accordance with one or more embodiments of the present disclosure.

The embodiments set forth in the drawing are illustrative in nature and not intended to be limiting of the invention defined by the claims. Moreover, individual features of the drawing and invention will be more fully apparent and understood in view of the detailed description.

### DETAILED DESCRIPTION

Embodiments of the present disclosure are directed to heavy metal sorbents comprising monolith structures functionalized with chitosan, the methods of making these sorbents, and the methods of using these sorbents to improve heavy metal removal. While the Examples below show the removal of heavy metals in industrial wastewater, the present sorbents are contemplated for use in any fluid sample, and are also considered suitable for gaseous contaminant removal.

As used herein “heavy metal” encompasses elements such as cadmium, mercury, chromium, lead, barium, beryllium, nickel, cobalt, vanadium, zinc, copper, manganese, antimony, silver, thallium, arsenic or selenium, any of which may be in any oxidation state and may be in elemental form or in a chemical compound comprising the element.

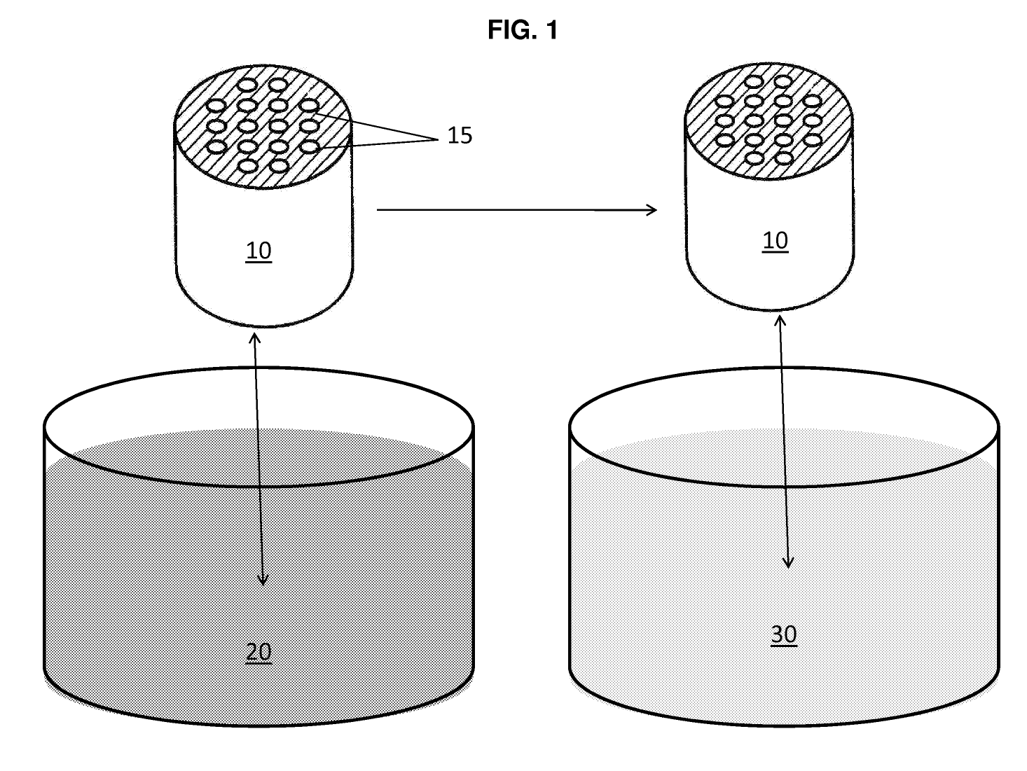

Referring to FIG. 1, the present sorbents comprise a monolith 10 having a plurality of internal channels 15 for liquids or gases to flow through. The sorbents comprise at least one silica coating disposed on the walls of the plurality of internal channels 15, and at least one chitosan coating disposed on the silica coating. In addition, the silica and chitosan coatings may be present on the non-channel surfaces of the monolith as well. As used herein, “on” does not necessarily mean directly contacting the next layer, and contemplates additional intervening layers between the channel walls and the silica coating or intervening layers between the silica coating and the chitosan coating. Additionally, the meaning of “on” contemplates that the silica or chitosan coatings are on the surface of the monolith, but may also be partially distributed or embedded in the surfaces or pores of the monolith. Furthermore, the phrase “at least one” contemplates that the sorbents may include multiple silica coatings or multiple chitosan coatings.

The monolith, which may define various structural shapes, is the backbone of the sorbent structure. In one embodiment, the monolith is a honeycomb structure. Various compositions are contemplated for the monolith. In one embodiment, the monolith comprises ceramic material. In one specific embodiment, the ceramic material is cordierite. Optionally in addition to the ceramic material (e.g., cordierite) present in the monolith, the monolith may also include additional components coated or blended therewith. For example and not by way of limitation, these additional components may include activated carbon, sulfur, other metal catalysts, binders, fillers, etc. Suitable metal catalysts may include the metal catalysts listed in U.S. Pat. No. 7,998,898, which is incorporated by reference herein in its entirety. As would be familiar to the skilled artisan, the monolith is typically formed by extrusion of a mixture comprising cordierite and other components, such as a binder.

In one exemplary embodiment, the silica coating may be composed primarily of silicon dioxide; however, other additional compositions are contemplated as being present in the silica coating. Similarly, in additional embodiments, the chitosan coating may include various additional components in addition to the chitosan.

Referring to FIG. 1, the method of making a sorbent comprises the steps applying a silica coating solution 20 onto the monolith 10 to achieve the silica coating. It is contemplated that the monolith may be washed or pretreated prior to the application of the silica and chitosan coatings. Alternatively, it is contemplated that the monolith is directly coated after it is extrusion formed.

Various compositions and compositional amounts for the silica coating solution are considered suitable. In one embodiment, the silica coating solution is an aqueous solution comprising colloidal silica. Regarding the composition, the silica coating solution may comprise from about 20 to about 50% by weight of colloidal silica, or from about 30 to about 40% by weight of colloidal silica. Commercially suitable silica coating solutions include the LUDOX® (30% or 40% by wt. colloidal silica) products manufactured by Sigma-Aldrich. While FIG. 1 depicts dip coating in which the monolith is immersed in a bath of the silica coating solution, other application or deposition techniques, such as spray coating may be utilized.

Prior to the application of the chitosan coating, the following optional process steps may be performed. For example, it may be desirable to deliver pressurized air to clear the channels of the monolith after the application of the silica coating solution. Additionally, the silica-coated monolith may also be dried and/or calcined prior to the application of the chitosan coating solution. For example, the monolith may be dried at 50° C. for 10 min.

Referring again to FIG. 1, the chitosan coating is applied on the silica coating by applying a chitosan coating solution 30. Like the silica coating solution, the chitosan coating solution may be applied via dip coating, spray coating, or various other suitable application or deposition techniques. Various components are contemplated for the chitosan coating solution. In addition to chitosan, the chitosan coating solution may comprise chitosan, at least one alcohol, and at least one acid. In one embodiment, the alcohol may comprise polyols. In an exemplary embodiment, the polyol is glycerol. The acids may include organic or mineral acids. In one exemplary embodiment, the acid is a weak organic acid such as acetic acid. The chitosan coating solution may comprise from about 0.5 to about 10% by weight of chitosan, or from about 1 to about 3% by weight of chitosan.

After application of the chitosan coating, the following additional steps may be conducted. Due to the acidity of the chitosan coating solution, a basic solution may be added to stabilize the chitosan coating solution. The basic solution may comprise one or more metal hydroxides, such as sodium hydroxide. Additionally, various washing steps may be utilized. For example, the process may include multiple solvent washing steps, wherein the solvents utilized are glycerol, deionized (DI) water, or ethanol. Finally, the chitosan-coated monoliths may be dried. In specific embodiments, the chitosan-coated monolith is air dried at ambient temperature.

As demonstrated in the examples below, these chitosan-coated monolith sorbents demonstrate excellent efficiency in removing heavy metal ions.

### EXAMPLES

For the adsorption experiments described in Examples 1-4 below, cordierite honeycomb monolith sorbents were coated at different chitosan concentrations in acetic acid solution and were then immersed in 40 ml of synthetic wastewater containing mixed metals of 126 ppm Al, 7.3 pm Cu, 3.9 ppm Se, 171 ppb Cd, 66 ppb As and 116 ppb Hg. The synthetic wastewater was prepared based on flue gas desulfurization (FGD) wastewater metal concentration. The sorbent in solution was agitated on a mechanical shaker for 8 hours using a Barnstead LABQUAKE Tube Shaker manufactured by Thermo Scientific. The changes in metal ion concentrations and metal ion removal efficiency due to adsorption are determined. Also, the amounts of adsorbed metal ions were calculated from the differences between their concentrations before and after adsorption. These results are captured in Tables 1-4 below.

### Example 1

### 1% by wt Chitosan-Coated Monolith

In Example 1, the silica-coated monoliths were prepared by dip coating. Next, the channels were cleared with pressurized air, and then the silica-coated monoliths were dried and calcined. The chitosan solution was prepared by dissolving 1.0 g chitosan powder and 1.0 g glycerol in 100 ml of 1% (v/v) acetic acid solution. Subsequently, the silica-coated monoliths were dipped in the chitosan solution for 20 min. After clearing the channels, the samples were dried at 50° C. for 10 min and then soaked in 5 wt % NaOH for 15 min to neutralize the acetic acid within the chitosan coating. The sorbent was then washed thoroughly in DI water and soaked in 20 wt % glycerol solution for 30 min Excess glycerol was removed by washing in DI water. Finally, the sample was soaked in ethanol for 1 hour and air dried. The chitosan coating on the monolith weighed about 20 mg. As shown in Table 1 below, the Example 1 sorbent, which had a 1% by wt. chitosan coating, showed excellent efficiency in removing heavy metals with removal efficiency ranging from 86.4-99.5% depending on metal species in the solution.

TABLE 1

| | Metal | Metal | |
|---|---|---|---|
| | Concentration | Concentration | Metal Removal |
| | Before Sorption | after | Efficiency |
| Metal | (ppb) | Sorption (ppb) | (%) |
| Al | 126000 | 2000 | 98.4 |
| Cu | 7600 | 120 | 98.4 |
| Se | 3600 | 500 | 87.1 |
| As | 66 | 9 | 86.4 |
| Cd | 171 | 23 | 86.6 |
| Hg | 116 | 5 | 95.7 |

### Example 2

### 2% by wt Chitosan-Coated Monolith

In example 2, the chitosan solution was prepared by dissolving 2.0 g chitosan powder and 2.0 g glycerol in 100 ml of 2% (v/v) acetic acid solution. Silica-coated monoliths prepared according to the methods described in Example 1, were dipped in the chitosan solution for 20 min. Post-treatment of the coated samples and evaluation of their metal removal efficiency were carried out in the same manner as under Example 1. The chitosan coating on the monolith weighed about 27 mg. As shown in Table 2 below, the Example 2 sorbents, which had a 2% by wt. chitosan coating, showed excellent efficiency in removing heavy metals with removal efficiency ranging from 87.9-99.6% depending on metal species in the solution.

TABLE 2

| | Metal | Metal | |
|---|---|---|---|
| | Concentration | Concentration | Metal Removal |
| | Before Sorption | after | Efficiency |
| Metal | (ppb) | Sorption (ppb) | (%) |
| Al | 126000 | 620 | 99.5 |
| Cu | 7320 | 30 | 99.6 |
| Se | 3890 | 370 | 90.5 |
| As | 66 | 8 | 87.9 |
| Cd | 171 | 20 | 88.3 |
| Hg | 116 | <5 | >95.7 |

### Example 3

### 3% by wt Chitosan-Coated Monolith

In Example 3, the chitosan solution was prepared by dissolving 3.0 g chitosan powder and 3.0 g glycerol in 100 ml of 3% (v/v) acetic acid solution. Silica-coated monoliths prepared according to the methods described above, were dipped in the chitosan solution for 20 min. Post-treatment of the coated samples and evaluation of their metal removal efficiency were carried out in the same manner as under Example 1 The chitosan coating on the monolith weighed about 54 mg. As shown in Table 3 below, the Example 3 sorbents, which had a 3% by wt. chitosan coating, achieved a very high metal removal performance with removal efficiency ranging from 92-100% depending on metal species in the solution.

TABLE 3

| | Metal | Metal | |
|---|---|---|---|
| | Concentration | Concentration | Metal Removal |
| | Before Sorption | after | Efficiency |
| Metal | (ppb) | Sorption (ppb) | (%) |
| Al | 126000 | 20 | ~100 |
| Cu | 7320 | 5 | 99.9 |
| Se | 3890 | 250 | 93.6 |
| As | 66 | <5 | >92.4 |
| Cd | 171 | <5 | >97.1 |
| Hg | 116 | <5 | >95.7 |

### Example 4

### Comparison of 3 Monolith Sorbents Having 3% by wt Chitosan Coating

In example 4, 3 chitosan-coated sorbents, each with 3% by wt chitosan coatings, were prepared and tested under identical conditions used in Example 3 with the purpose of demonstrating the repeatability of the metal removal performance of the coated sorbents. The test results presented in Table 4 below demonstrate this repeatability.

TABLE 4

Metal removal Efficiency (%)

| Sample # | Al | Cd | Cu | Hg | As | Se |
|---|---|---|---|---|---|---|
| Sample 1 | 98.8 | 99.7 | 94.7 | 97.5 | 97.6 | 80.7 |
| Sample 2 | 98.5 | 99.7 | 97.9 | 98.6 | 97.6 | 80.1 |
| Sample 3 | 98.6 | 99.7 | 98.6 | 99.5 | 97.6 | 81.2 |

It is further noted that terms like “preferably,” “generally,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present disclosure.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

What is claimed is:

1. A method of making a sorbent comprising:
providing a monolith having a plurality of internal channels;
providing at least one silica coating onto walls of the plurality of internal channels by applying a silica coating solution; and
providing at least one chitosan coating on the silica coating by applying a chitosan coating solution.

2. The method of claim 1 wherein the silica coating solution is an aqueous solution comprising colloidal silica.

3. The method of claim 2 wherein the silica coating solution comprises from about 20 to about 50% by weight of colloidal silica.

4. The method of claim 3 wherein the silica coating solution comprises from about 30 to about 40% by weight of colloidal silica.

5. The method of claim 1 wherein the silica coating solution is applied via dip coating, spray coating, or combinations thereof.

6. The method of claim 1 wherein the monolith is a honeycomb.

7. The method of claim 1 wherein the monolith comprises cordierite.

8. The method of claim 1 wherein the chitosan coating solution is applied via dip coating, spray coating, or other suitable deposition techniques.

9. The method of claim 1 wherein the chitosan coating solution comprises chitosan, at least one alcohol, and at least one acid.

10. The method of claim 9 wherein the alcohol comprises polyols.

11. The method of claim 10 wherein the polyol comprises glycerol.

12. The method of claim 1 wherein the acid comprises acetic acid.

13. The method of claim 1 wherein the chitosan coating solution comprises from about 0.5 to about 10% by weight of chitosan.

14. The method of claim 13 wherein the chitosan coating solution comprises from about 1 to about 3% by weight of chitosan

15. The method of claim 9 further comprising stabilizing the chitosan coating by adding a basic solution.

16. A sorbent comprising:
a monolith having a plurality of internal channels;
at least one silica coating disposed on walls of the plurality of internal channels; and
at least one chitosan coating disposed on the at least one silica coating.

17. The sorbent of claim 16 wherein the monolith is a honeycomb.

18. The sorbent of claim 16 wherein the monolith comprises ceramic.

19. The sorbent of claim 16 wherein the monolith comprises cordierite.

20. A method of removing heavy metals from a fluid stream comprising filtering the fluid stream with the sorbent of claim 16.
